(19) United States
(12) Patent Application Publication
(10) Pub. No.: US 2026/0329624 A1
(43) Pub. Date: Oct. 22, 2026

(54) TASK MESSAGE TRANSMISSION

(71) Applicant: TENCENT TECHNOLOGY (SHENZHEN) COMPANY LIMITED, Shenzhen (CN)

(72) Inventors: Dajiang SI, Shenzhen (CN); Yuquan ZHU, Shenzhen (CN); Jing SUN, Shenzhen (CN); Shuchao PENG, Shenzhen (CN); Dekai LI, Shenzhen (CN); Li LI, Shenzhen (CN)

(73) Assignee: TENCENT TECHNOLOGY (SHENZHEN) COMPANY LIMITED, Shenzhen, GD (CN)

(21) Appl. No.: 19/668,564

(22) Filed: May 5, 2026

Related U.S. Application Data
(63) Continuation of application No. PCT/CN2024/134448, filed on Nov. 26, 2024.

(30) Foreign Application Priority Data
Jan. 25, 2024 (CN) 202410101868.4

(51) Int. Cl. G06F 9/48; G06F 9/54

(52) U.S. Cl. CPC G06F 9/4831; G06F 9/546; G06F 2209/548

(57) ABSTRACT

In methods of task message transmission, task execution data of a task execution system in a preset time period is obtained when the task execution system executes tasks that are carried in a plurality of task messages in the preset time period. Execution stage information of the task execution system is determined based on the task execution data. When the execution stage information indicates that the task execution system is at a first execution stage corresponding to a peak hour for the task execution system, a first priority of a first task message to be transmitted to the task execution system is calculated. The first task message is inserted into a first target position of a buffer queue based on the first priority. The first task message is transmitted to the task execution system by using the buffer queue. Apparatus and non-transitory computer-readable storage medium counterpart embodiments are also contemplated.

### RELATED APPLICATIONS

The present application is a continuation of International Application No. PCT/CN2024/134448, filed on Nov. 26, 2024, which claims priority to Chinese Patent Application No. 202410101868.4, filed on Jan. 25, 2024. The entire disclosures of the prior applications are hereby incorporated by reference.

### FIELD OF THE TECHNOLOGY

This disclosure relates to the field of cloud technologies, including task message transmission methods and apparatuses, electronic devices, storage media, and program products.

### BACKGROUND OF THE DISCLOSURE

With the development of cloud technologies, cloud manufacturers may provide increasingly diversified cloud services. In some examples, a cloud service user may transmit a request message to a cloud manufacturer by using a computer device. The cloud manufacturer may generate a task message based on the request message, transmit the task message to a task execution system for processing the task message, to provide a cloud service requested by the cloud service user to the cloud service user.

However, in an actual work scenario, resource configuration of the task execution system, a processing amount of task messages, and the like all change, but these changes may not be sensed in the foregoing solution, making it difficult to match a task message transmission process with a task processing situation of the task execution system, and causing poor flexibility of the task message transmission process.

### SUMMARY

Embodiments of this disclosure provide task message transmission methods and apparatuses, electronic devices, storage media, and program products, which can improve flexibility of transmitting a task message.

Some aspects of the disclosure provide a method of task message transmission. For example, task execution data of a task execution system in a preset time period is obtained when the task execution system executes tasks that are carried in a plurality of task messages in the preset time period. Execution stage information of the task execution system is determined based on the task execution data. When the execution stage information indicates that the task execution system is at a first execution stage corresponding to a peak hour for the task execution system, a first priority of a first task message to be transmitted to the task execution system is calculated. The first task message is inserted into a first target position of a buffer queue based on the first priority. The first task message is transmitted to the task execution system by using the buffer queue.

Some aspects of the disclosure provide an apparatus. Processing circuitry in the apparatus is configured to obtain task execution data of a task execution system in a preset time period when the task execution system executes tasks that are carried in a plurality of task messages in the preset time period, and to determine execution stage information of the task execution system based on the task execution data. When the execution stage information indicates that the task execution system is at a first execution stage corresponding to a peak hour for the task execution system, the processing circuitry calculates a first priority of a first task message to be transmitted to the task execution system, and inserts the first task message into a first target position of a buffer queue based on the first priority. The first task message is transmitted to the task execution system by using the buffer queue.

Some aspects of the disclosure provide a non-transitory computer-readable storage medium storing instructions which when executed by at least one processor cause the at least one processor to perform any of the methods of task message transmission described herein.

According to an aspect, an embodiment of this disclosure provides a task message transmission method, performed by an electronic device. The method includes: obtaining task execution data of a task execution system, the task execution system being configured to process a plurality of task messages, and the task execution data including indicator data generated by the task execution system when executing tasks carried in the task messages in a preset time period; determining execution stage information of the task execution system based on the task execution data; calculating, when the execution stage information represents that the task execution system is at a first execution stage, a first priority of a first task message to be transmitted at the first execution stage; and inserting the first task message into a first target position of a buffer queue based on the first priority, and transmitting the first task message to the task execution system by using the buffer queue.

According to another aspect, an embodiment of this disclosure further provides a task message transmission apparatus. The apparatus includes: an execution data obtaining module, configured to obtain task execution data of a task execution system, the task execution system being configured to process a plurality of task messages, and the task execution data including indicator data generated by the task execution system when executing tasks carried in the task messages in a preset time period; an execution stage determining module, configured to determine execution stage information of the task execution system based on the task execution data; a first stage module, configured to calculate, when the execution stage information represents that the task execution system is at a first execution stage, a first priority of a first task message to be transmitted at the first execution stage; and a transmission module, configured to insert the first task message into a first target position of a buffer queue based on the first priority, and transmit the first task message to the task execution system by using the buffer queue.

According to another aspect, an embodiment of this disclosure further provides an electronic device, including a processor (an example of processing circuitry) and a memory. The memory has a computer program stored therein, and the processor is configured to run the computer program in the memory, to implement operations of the task message transmission method provided in the embodiments of this disclosure.

According to another aspect, an embodiment of this disclosure further provides a computer-readable storage medium (e.g., non-transitory computer-readable storage medium), having a computer program stored therein. The computer program is executed by a processor to implement operations of the task message transmission method provided in the embodiments of this disclosure.

According to another aspect, an embodiment of this disclosure further provides a computer program product, including a computer program/instructions. The computer program/the instructions are executed by a processor to implement operations of the task message transmission method provided in the embodiments of this disclosure.

### BRIEF DESCRIPTION OF THE DRAWINGS

FIG. 1 is a schematic structural diagram of a cloud service system to which an embodiment of this disclosure is applied.

FIG. 2 is a schematic flowchart of a task message transmission method according to an embodiment of this disclosure.

FIG. 3 is another schematic flowchart of a task message transmission method according to an embodiment of this disclosure.

FIG. 4 is a schematic structural diagram of a cloud service provider according to an embodiment of this disclosure.

FIG. 5 is another schematic flowchart of a task message transmission method according to an embodiment of this disclosure.

FIG. 6 is a schematic structural diagram of a task message transmission apparatus according to an embodiment of this disclosure.

FIG. 7 is a schematic structural diagram of an electronic device according to an embodiment of this disclosure.

### DETAILED DESCRIPTION

The following describes technical solutions in embodiments of this disclosure with reference to the accompanying drawings. The described embodiments are some of the embodiments of this disclosure rather than all of the embodiments. Other embodiments are within the scope of this disclosure.

Examples of terms involved in the aspects of the disclosure are briefly introduced. The descriptions of the terms are provided as examples only and are not intended to limit the scope of the disclosure.

In the specification, claims, and accompanying drawings of this disclosure, the terms “first”, “second”, “third”, “fourth”, and the like (if existent) are intended to distinguish between similar objects but do not necessarily indicate a specific order or sequence. Data used in this way may be interchanged in an appropriate case, so that the embodiments of this disclosure described herein can be implemented in a sequence other than the sequence illustrated or described herein. In addition, the terms “include” and “correspond” and any other variants are intended to cover the non-exclusive inclusion. For example, a process, method, system, product, or device that includes a list of steps or units is not necessarily limited to those expressly listed steps or units, but may include other steps or units not expressly listed or inherent to such a process, method, product, or device.

Data related to user information (for example, a task message) and the like is involved in several embodiments of this disclosure. When the embodiments of this disclosure are applied to a specific product or technology, the user's permission or consent needs to be obtained, and collection, use, and processing of the relevant data need to comply with relevant laws, regulations, and standards of relevant countries and regions.

The cloud technology is a collective name of a network technology, an information technology, an integration technology, a management platform technology, an application technology, and the like based on an application of a cloud computing business mode. A background service of a technical network system requires a large amount of computing and storage resources, such as video websites, image websites, and more portal websites. Various types of industry data need to be supported by a powerful cloud computing system. Cloud computing refers to the delivery and use mode of service, which refers to obtaining a required service through the network in an on-demand and scalable manner. The cloud computing includes grid computing, distributed computing, parallel computing, utility computing, network storage technologies, virtualization, and load balancing.

The embodiments of this disclosure relate to how to transmit and process a task message from a user more flexibly and efficiently when a cloud computing service provider (referred to as a cloud service provider for short, or referred to as a cloud manufacturer) provides a cloud computing service to the user, thereby improving stability of supplying the cloud computing service.

The embodiments of this disclosure provide a task message transmission method and apparatus, an electronic device, a storage medium, and a program product. The task message transmission apparatus may be integrated into a task message transmission system (referred to as a task transmission system for short). The task transmission system may be integrated on at least one electronic device, and the electronic device may include at least one of a terminal or a server.

A task execution system in the embodiments of this disclosure may be integrated on at least one electronic device, and the electronic device may include at least one of a terminal or a server.

The task transmission system and the task execution system in the embodiments of this disclosure may be integrated on a same electronic device (or a plurality of electronic devices), or may be separately integrated on different electronic devices. In some examples, flexible processing may be performed based on an actual situation. Details are not described herein again.

The server may be an independent physical server, or may be a server cluster including a plurality of physical servers or a distributed system, or may be a cloud server providing basic cloud computing services, such as a cloud service, a cloud database, cloud computing, a cloud function, cloud storage, a network service, cloud communication, a middleware service, a domain name service, a security service, a content delivery network (CDN), big data, and an artificial intelligence platform. The terminal may be a smartphone, a tablet computer, a notebook computer, a desktop computer, a smart speaker, a smartwatch, or the like, but is not limited thereto. The terminal and the server may be directly or indirectly connected in a wired or wireless communication manner. This is not limited herein in this disclosure.

In the embodiments of this disclosure, the task transmission system may receive a task message generated in real time, and transmit the task message to the task execution system. The task execution system is configured to process the task message.

To improve consistency between a task message transmission process and a task message processing process, the task transmission system may obtain task execution data of the task execution system, where the task execution data includes various indicator data of the task execution system in the task message processing process; and then determine execution stage information of the task execution system based on the task execution data. When the task execution system is at different execution stages, different manners may be used to transmit the task message to the task execution system.

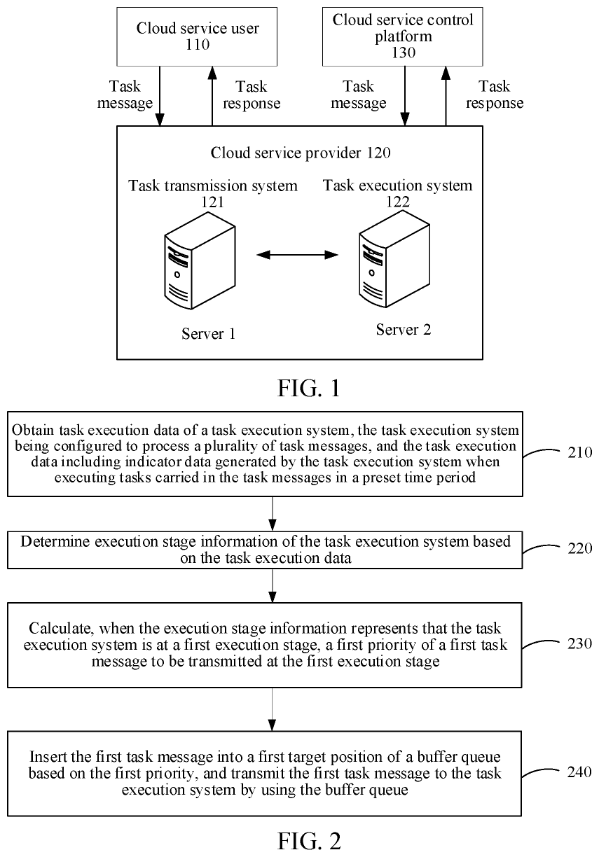

FIG. 1 is a schematic structural diagram of a cloud service system to which an embodiment of this disclosure is applied. The entire cloud service system includes a cloud service user 110, a cloud service provider 120, and a cloud service control platform 130.

The cloud service user 110 is a user, an enterprise, or another organization that uses various cloud services. The cloud service control platform 130 is a unified platform controlling the cloud service provider 120 to provide a cloud service to the cloud service user 110. Both the cloud service user 110 and the cloud service control platform 130 may transmit a to-be-processed task message like a request message or a control message to the cloud service provider 120, and receive a task response corresponding to the task message from the cloud service provider 120.

The cloud service provider 120 includes a task transmission system 121 and a task execution system 122. In another example, the cloud service provider 120 may further include other related systems and functional modules. Details are not further described herein.

The task transmission system 121 and the task execution system 122 may be separately integrated on a server 1 and a server 2. The task transmission system 121 may receive the task message from the cloud service user 110 and the cloud service control platform 130, and obtain indicator data (task execution data for short) of the task execution system 122 in a task message processing process, to determine execution stage information of the task execution system 122 based on the task execution data, and then transmit the task message to the task execution system 122 in different manners based on the execution stage information.

For example, the execution stage information represents that the task execution system 122 is in a peak hour. In this case, a priority P1 of a task message M1 received in the peak hour may be calculated, and then the task message M1 may be stored at a position P1 of a buffer queue based on the priority P1, so that the task message M1 with a relatively high priority is transmitted to the task execution system 122 more quickly by using the buffer queue.

For another example, the execution stage information represents that the task execution system is in a non-peak hour. In this case, a task message M2 received in the non-peak hour may be directly transmitted to the task execution system 122.

FIG. 1 shows an example of an application scenario of transmitting a task message according to this disclosure, and is configured to describe the task transmission system described in this embodiment of this disclosure. During actual use of the technical solutions described in the embodiments of this disclosure, electronic devices and operations performed by the electronic devices in the task message transmission method may be flexibly adjusted, and are not limited to the content described in FIG. 1.

The task message transmission method in this disclosure is further described below with reference to the embodiments. The description sequence of the following embodiments is not intended to limit preference orders of the embodiments.

The embodiments of this disclosure address task scheduling in a cloud computing environment. Factors such as priorities, availability, observability, and scheduling performance of tasks are considered. The tasks are logically queued based on the priorities, and dynamic adjustment is performed based on characteristics of the tasks and a load of a queue, to achieve a desired task scheduling effect. Advantages lie in that, different priorities can be assigned to different tasks based on importance and urgency degrees of the tasks, to help ensure that an important task is processed. In addition, the availability and the observability of the tasks are considered, so that stability and reliability of a system can be improved. Finally, the load of the queue is dynamically adjusted, so that efficiency and scheduling performance of the system can be improved.

FIG. 2 is a schematic flowchart of a task message transmission method according to this disclosure. For example, the task message transmission method is performed by an electronic device, for example, the server 1 integrated with the task transmission system 121 in FIG. 1. As shown in FIG. 2, the task message transmission method may include the following operations.

210: Obtain task execution data of a task execution system, the task execution system being configured to process a plurality of task messages, and the task execution data including indicator data generated by the task execution system when executing tasks carried in the task messages in a preset time period. For example, task execution data of a task execution system in a preset time period is obtained when the task execution system executes tasks that are carried in a plurality of task messages in the preset time period.

The task message may include a request message from a cloud service user and/or a control message from a cloud service control platform. The task message carries information about at least one task. The task may include any task that may be involved in a cloud computing mode. For example, the control message indicates inventory calculation, cloud server creation, cloud server fault migration, and the like; and the request message indicates password modification, data deletion/modification/addition, and the like.

The control message transmitted by the cloud service control platform may alternatively be that the cloud service control platform generates a specific control instruction after receiving the request message from the cloud service user, encapsulates the control instruction into a new message, uses the new message as the control message, and transmits the control message to the task transmission system.

The task execution system is a system processing the task message, and is configured to process the at least one task carried in the task message, so that a cloud service provider can provide a cloud service requested by the cloud service user to the cloud service user, and the cloud service provider can also stably run under control of the cloud service control platform.

In some examples, the task execution system may include a plurality of message queues and a plurality of task worker threads. One message queue may correspond to at least one task worker thread, and one task worker thread may correspond to at least one message queue. The message queues may be configured to temporarily store task messages, and sequentially deliver the task messages to the task worker threads. A task corresponding to a task message may be processed by at least one task worker thread.

The task execution data may include indicator data generated by the task execution system in a task message processing process. The task execution data may include indicator data of the message queues, indicator data of the task worker threads, and the like. The preset time period may be a period of time in preset duration before a current time point, and is a historical time period. The duration may be set by balancing efficiency and precision of task scheduling.

The indicator data of the message queues may include indicator data of the message queues and indicator data of the task messages temporarily stored in the message queues, and may be for example, a quantity of task messages in a message queue, a quantity of message queues, a quantity of non-empty message queues, stay duration of a task message in the message queue, and congestion indicator data of the message queue.

The indicator data of the task worker threads may include indicator data of the task worker threads and indicator data of the task messages processed by the task worker threads, and may be for example, a quantity of task messages processed by a task worker thread or a quantity of tasks executed by a task worker thread, a quantity of task worker threads, a quantity of abnormal task worker threads, and a quantity of task worker threads processing task messages.

In this embodiment of this disclosure, the task execution data may include reported task execution data and processed task execution data.

In an example, the task execution system directly reports the task execution data to the task transmission system.

In another example, the cloud service provider further includes a module processing the task execution data. The module obtains current task execution data from the task execution system, processes all or a part of the received task execution data to obtain new task execution data, and then transmits processed new task execution data to the task transmission system.

In some embodiments of this disclosure, system status information of the task execution system may be first determined based on some pieces of task execution data, and then different processing may be performed on to-be-transmitted task messages in different task statuses based on a system status of the task execution system represented by the system status information.

The system status information may include status information representing whether the task execution system normally runs. The system status information may include first status information and second status information. The first status information may represent that the task execution system is in a first system status. The first system status may include a system abnormal state. The second status information may represent that the task execution system is in a second system status. The second system status may include a system normal state.

In some embodiments of this disclosure, the task execution data may include congestion indicator data of the message queues, and the congestion indicator data may include data reflecting congestion degrees of the message queues. For example, a quantity of task messages accumulated in the message queue may be used as a type of congestion indicator data. In some examples, the congestion indicator data may be flexibly selected in an actual application scenario, and is not limited herein.

If the congestion indicator data matches a preset third threshold, it is determined that the task execution system corresponds to the first status information. The matching may include being greater than the third threshold, being greater than or equal to the third threshold, a difference between the congestion indicator data and the preset third threshold being greater than a value, or the like. For example, a plurality of message queues may correspond to congestion indicator data D1. If the congestion indicator data D1 is greater than a threshold, it may be determined that the task execution system is in the abnormal state.

In some embodiments of this disclosure, respective execution result data of a first quantity of task messages in the task execution system may also be obtained. The execution result data may represent whether tasks corresponding to the task messages are successfully executed. Then, a task execution success rate of the task execution system may be evaluated based on the execution result data.

A process of calculating the task execution success rate may include: determining that a task message whose execution result data indicates successful execution is a target task message, and obtaining a second quantity of target task messages through statistics collection; and calculating the task execution success rate of the task execution system based on the first quantity and the second quantity.

If execution result data indicates that a task message is successfully executed, it is determined that the task message is a target task message. The foregoing operation is performed on all execution result data, to finally obtain the second quantity of target task messages, where the second quantity is less than or equal to the first quantity. A quotient of the second quantity and the first quantity is solved to obtain the task execution success rate.

If the task execution success rate matches a preset second threshold, it is determined that the system status information of the task execution system is the first status information. The matching may include being less than the second threshold, being less than or equal to the second threshold, a difference between the task execution success rate and the second threshold being greater than or less than a value, or the like.

For example, execution result data of 100 task messages is obtained, and it is determined that a task message whose execution result data represents successful execution is a target task message, to obtain 20 target task messages. The task execution success rate is calculated as: 20/100=0.2, where 0.2 is less than a threshold 0.3, so that it is determined that the task execution system is in the abnormal state.

In some embodiments of this disclosure, the task execution data may include a quantity of task worker threads processing task messages or executing tasks in the task execution system in the preset time period, which is referred to as a task thread quantity for short. Limited by a factor like system performance, a total quantity of task worker threads that can be configured by the task execution system (that is, a preset fourth threshold) is limited. Therefore, it may be compared whether the task thread quantity matches the fourth threshold, and if the task thread quantity matches the fourth threshold, it is determined that the system status information of the task execution system is the first status information. The matching herein may be, for example, being equal, or a difference between the task thread quantity and the fourth threshold being less than a preset threshold.

For example, a task thread quantity C of the task execution system is obtained, and if the task thread quantity C is equal to a maximum thread quantity of the task execution system, it is determined that the task execution system reaches a capacity expansion upper limit and is in the abnormal state.

In this embodiment of this disclosure, when the system status information represents that the task execution system is in the first system status, a task message (for example, a third task message) to be transmitted in the first system status may be processed based on task type information of the task message.

In some examples, the third task message is discarded when task type information of the third task message matches a preset task type; and when the task type information of the third task message does not match the preset task type, a second priority of the third task message is calculated, the third task message is inserted into a second target position of a buffer queue based on the second priority, and the third task message is transmitted to the task execution system by using the buffer queue.

Therefore, in this embodiment of this disclosure, after it is determined that the task execution system is in the abnormal state, a task message with relatively low importance may be first discarded based on task type information, to initially alleviate a task processing load of the abnormal task execution system, and improve stability of the task execution system and even the cloud service provider in an abnormal situation.

The task type information may include type information of a task carried in the task message. In some examples, there may be a plurality of division manners for task types. In this embodiment of this disclosure, to help ensure smooth use of a cloud service by the cloud service user, division may be performed based on bodies (the cloud service user/the cloud service control platform) corresponding to the tasks, division may be performed based on importance of the tasks to the cloud service user, division may be performed based on features of the tasks, or the like.

The preset task type may include a type having relatively low importance to the cloud service user, a type that a body corresponding to a task is not the cloud service user, or the like.

Matching between the task type information and the preset task type may be understood as being equal, similar, or the like. Both the preset task type and the matching may be flexibly selected and processed in an actual application scenario, and are not limited herein.

For example, after the task execution system is determined to be in the abnormal state, a task type TA of a task message M3 may be obtained, and a determination may be made whether the task type TA matches a preset task type T1. If the task type TA matches the preset task type T1, the task message M3 is directly discarded. If the task type TA does not match the preset task type T1, a priority P3 of the task message M3 may be calculated, then a position of the task message M3 in the buffer queue may be determined based on the priority P3, and finally, the task message M3 may be transmitted to the task execution system by using the buffer queue.

Correspondingly, in some embodiments of this disclosure, when the task execution success rate does not match the preset second threshold, the congestion indicator data does not match the preset third threshold, and the task thread quantity (that is, the quantity of task worker threads executing the tasks) does not match the preset fourth threshold, it is determined that the system status information of the task execution system is the second status information. The second status information represents that the task execution system is in the second system status, that is, the system normal state.

For example, if the congestion indicator data of the task execution system is less than the third threshold, the task execution success rate is greater than the second threshold, and the task thread quantity is less than the maximum thread quantity of the task execution system, it may be determined that the task execution system is in the normal state.

In some embodiments of this disclosure, if the second status information of the task execution system represents that the task execution system is in the second system status, operation 220 may be performed.

220: Determine execution stage information of the task execution system based on the task execution data.

The execution stage information may include information representing a stage of the task execution system. The task execution system may be at different stages. For example, the execution stage information may include first stage information and second stage information. The first stage information may represent that the task execution system is at a first execution stage. The first execution stage may be, for example, a peak hour in which processing pressure of the task execution system is relatively large. The second stage information may represent that the task execution system is at a second execution stage. The second execution stage may be, for example, a non-peak hour in which the processing pressure of the task execution system is normal or relatively low.

In an example, a division criterion of execution stages may be a busy degree of processing the task messages by the task execution system. A quantization manner of the busy degree may be, for example, an average quantity of task messages processed by all task worker threads working in the task execution system per unit time. A higher average quantity indicates a busier task execution system.

In another example, the division criterion of the execution stages may alternatively be a difference between a quantity of to-be-transmitted task messages and a current processing capability of the task execution system. A quantization manner of the difference may be, for example, a ratio of the quantity of to-be-transmitted task messages to a quantity of task messages that have been processed by the task execution system in a historical time period (that is, a quantity of executed tasks). When the ratio is greater than 1, the task execution system is about to process more task messages.

Correspondingly, there may be a plurality of manners of determining the execution stage information based on the task execution data.

In some embodiments of this disclosure, an average task execution quantity may be used, and the average task execution quantity is the average quantity of task messages processed by all working task worker threads per unit time.

In some examples, the task execution data may include a task execution quantity of each of the task worker threads in the preset time period and a quantity of task worker threads executing tasks in the preset time period. A quantity of processed task messages is the same as the quantity of executed tasks. A quantity of tasks executed by a task worker thread that does not process a task message is 0, and a task worker thread executing a task is a working task worker thread. A preset time period for collecting statistics on the task execution quantity and a preset time period for collecting statistics on an execution thread quantity may be the same or different.

Task execution quantities of all task worker threads may be summed up to obtain a total task execution quantity, and then a quotient of the total task execution quantity and the execution thread quantity may be solved to obtain the average task execution quantity of the task execution system.

Then, the execution stage information may be determined based on a matching result between a preset first threshold and the average task execution quantity.

When the average task execution quantity matches the preset first threshold, it is determined that the execution stage information is the first stage information.

When the average task execution quantity does not match the first threshold, it is determined that the execution stage information is the second stage information.

The first threshold may be preset. The matching may include being greater than, being greater than or equal to, a difference between the average task execution quantity and the first threshold being greater than a value, or the like.

For example, task execution quantities of 200 task worker threads processing task messages in the task execution system may be obtained: a task quantity X1 to a task quantity X200. (Task quantity X1+ . . . +task quantity X200)/200=average task execution quantity. If the average task execution quantity is greater than 6 (the preset first threshold), it is determined that the task execution system corresponds to the first stage information, that is, the task execution system is in the peak hour.

In some embodiments of this disclosure, task execution quantities of all task worker threads may be summed up to obtain a total task execution quantity, then a total to-be-transmitted quantity of to-be-transmitted task messages in the cloud service provider may be obtained, and a ratio of the total to-be-transmitted quantity to the total task execution quantity may be calculated. If the ratio is greater than a predetermined value, it is determined that the task execution system corresponds to the first stage information. If the ratio is not greater than the predetermined value, it is determined that the task execution system corresponds to the second stage information.

For example, a total quantity of tasks executed by the task execution system, that is, a total task execution quantity, in a historical time period may be determined; a total quantity of to-be-transmitted task messages in the cloud service provider, that is, a total to-be-transmitted quantity, may be obtained; and that P=total task execution quantity/total to-be-transmitted quantity may be calculated. If P is greater than 0.95, it is determined that the task execution system is in the peak hour; otherwise, it is determined that the task execution system is in the non-peak hour.

230: Calculate, when the execution stage information represents that the task execution system is at the first execution stage, a first priority of a first task message to be transmitted at the first execution stage. For example, when the execution stage information indicates that the task execution system is at a first execution stage corresponding to a peak hour for the task execution system, a first priority of a first task message to be transmitted to the task execution system is calculated.

240: Insert the first task message into a first target position of the buffer queue based on the first priority, and transmit the first task message to the task execution system by using the buffer queue. For example, the first task message is inserted into a first target position of a buffer queue based on the first priority. The first task message is transmitted to the task execution system by using the buffer queue.

The buffer queue may include a queue configured to temporarily store task messages. The buffer queue may be a priority queue. When a new task message needs to enter the buffer queue, the new task message may be temporarily stored at an appropriate position of the buffer queue based on a priority of the task message. Therefore, at the first execution stage, a more urgent task message with higher importance may be transmitted to the task execution system more quickly by using the buffer queue.

In this embodiment of this disclosure, after it is determined that the execution stage information of the task execution system represents that the task execution system is at the first execution stage, a task message (for example, the first task message) to be transmitted at the first execution stage may be processed. In some examples, the first priority of the first task message may be calculated, and then the first task message may be inserted into the first target position of the buffer queue based on the first priority.

In some examples, there may be a plurality of manners of determining the first priority of the first task message. For example, a correspondence table of task type information and priorities may be pre-constructed. Task type information of the first task message is first determined, then the correspondence table is searched for a priority corresponding to the task type information, and the priority is determined as the first priority of the first task message.

In some embodiments of this disclosure, transmission waiting duration of the first task message to be transmitted at the first execution stage may be obtained, a waiting duration threshold corresponding to the first task message may be determined, and then the first priority of the first task message may be calculated based on the transmission waiting duration and the waiting duration threshold.

Transmission waiting duration may include duration for which the task transmission system or the cloud service provider has waited. In some examples, a difference between a time point at which the task transmission system or the cloud service provider receives a task message and a current time point may be calculated, and the difference may be determined as the transmission waiting duration.

A waiting duration threshold may include a preset value, and the data may be flexibly set based on sensitivity of a task or a task type of the task to waiting duration, importance of the task or the task type of the task to the cloud service provider, and the like.

There may be a plurality of manners of determining the waiting duration threshold. For example, a preset first data table may be searched for a waiting duration threshold corresponding to a task carried in a task message, or a preset second data table may be queried for a waiting duration threshold corresponding to task type information of a task message.

A priority may represent a priority degree of one task message in all to-be-transmitted task messages. For example, cloud server creation is a task with a highest priority, a cloud service promoter needs to promise a service level agreement (SLA), and optimized execution is needed, to prevent a service loss. For another example, cloud service hot migration is a task with a low priority, and may be executed later when tasks are congested.

There may be a plurality of manners of determining the priority based on the waiting duration threshold and the transmission waiting duration. For example, the priority is determined based on a difference between the transmission waiting duration and the waiting duration threshold. If the difference is regular, the priority is higher, and a larger value indicates a higher priority. If the difference is zero, the priority is the second highest. If the difference is negative, the priority is lower, and a larger absolute value of the difference indicates a lower priority.

In some embodiments of this disclosure, a process of calculating the first priority based on the transmission waiting duration and the waiting duration threshold may include:
determining, when the transmission waiting duration is less than or equal to the waiting duration threshold, a first preset score corresponding to the first task message, and calculating the first priority based on the transmission waiting duration and the first preset score; and
determining, when the transmission waiting duration is greater than the waiting duration threshold, the first preset score and a second preset score corresponding to a difference between the transmission waiting duration and the waiting duration threshold, and calculating the first priority based on the first preset score, the waiting duration threshold, the second preset score, and the difference.

For details, reference may be made to the following formula:

T_score=W_t*W_s+D_t*D_s

T_score is the priority; W_s is the first preset score, and represents a weight in the waiting duration threshold; and D_s is the second preset score, and represents a weight outside the waiting duration threshold, that is, a weight corresponding to the foregoing difference.

When the transmission waiting duration is less than the waiting duration threshold, W_t is the transmission waiting duration, and D_t is zero.

When the transmission waiting duration is greater than the waiting duration threshold, W_t is the waiting duration threshold, and D_t is the difference between the transmission waiting duration and the waiting duration threshold.

Based on W_s and D_s, urgency degrees of waiting can be distinguished, and priority scheduling of a task that has waited for an excessively long time can be accelerated.

For example, transmission waiting duration of a task message M1 is 30 s, a corresponding waiting duration threshold is searched for based on a task carried in the task message M1 and is 40 s, it is determined that the transmission waiting duration being 30 s is less than the waiting duration threshold being 40 s, a first preset score corresponding to the task message M1 is obtained as 2, and a priority P1 of the task message M1 is that P1=30*2=60.

For another example, transmission waiting duration of a task message M2 is 100 s, a corresponding waiting duration threshold is searched for based on a task carried in the task message M2 and is 70 s, it is determined that the transmission waiting duration being 100 s is greater than the waiting duration threshold being 70 s, a first preset score being 4 and a second preset score being 10 that correspond to the task message M2 are obtained, and a priority P2 of the task message M2 is that P2=70*4+(100−70)*10=580.

Based on the foregoing scheduling mechanism, scheduling may be performed based on priorities of tasks and tolerance scheduling time (that is, W_t) of the tasks. Execution of an important task in a peak hour based on a priority of the task can be facilitated. A scheduling parameter is configured, to improve service scheduling efficiency, and help ensure stable running of services in the service peak hour.

In this embodiment, both the first preset score and the second preset score are preset values, and such values may be flexibly set based on sensitivity of a task or a task type of the task to waiting duration, importance of the task or the task type of the task to the cloud service provider, and the like.

There may be a plurality of manners of searching for the first preset score and the second preset score. For example, a preset third data table may be searched for a first preset score corresponding to a task carried in a task message.

In some embodiments of this disclosure, a process of determining the first preset score corresponding to the first task message further includes: obtaining a first preset type score table, the first preset type score table including a plurality of pieces of preset task type information and a preset score corresponding to each piece of task type information; and searching the first preset type score table for the first preset score corresponding to the task type information of the first task message.

For example, a preset score table is obtained. The preset score table includes a plurality of preset task types and a preset score corresponding to each preset task type. A task type T1 of the task message M1 is determined, the preset score table is searched for a preset score S1 corresponding to the task type T1, and the preset score S1 is determined as a first preset score corresponding to the task message M1.

In this embodiment of this disclosure, a process of determining the second preset score is similar to the process of determining the first preset score. Therefore, details are not described herein again.

In some examples, a process of inserting the first task message into the first target position of the buffer queue based on the first priority may include: sorting the first priority and an existing priority of at least one task message in the buffer queue, to obtain a sorting result of the first priority; and determining the first target position of the first task message in the buffer queue based on the sorting result, and inserting the first task message into the first target position.

The buffer queue may include a plurality of existing task messages, and each of the existing task messages corresponds to one existing priority. The existing task messages whose existing priorities are sorted in descending order are sequentially stored at the head to the tail of the buffer queue.

In this embodiment of this disclosure, the first priority and all existing priorities may be sorted, to determine the sorting result of the first priority in all priorities, and then the first task message may be inserted into the first target position corresponding to the sorting result. An existing task message close to the head of the queue beside the first target position has an existing priority higher than the first priority, and an existing task message close to the tail of the queue beside the first target position has an existing priority lower than the first priority.

Therefore, the first task message may be adjusted to an appropriate position, to improve flexibility of a task message transmission process. In this way, a task message with a high priority can be transmitted to the task execution system more quickly at the first execution stage or in the first system status, to improve transmission and processing efficiency of the task message while improving system stability.

For example, the buffer queue includes task messages M3 to M6, priorities P3 to P6 are sequentially 20, 40, 100, and 650, and it is determined that the priority P1 of the task message M1 is 60. The five priorities may be sorted, to determine that a sorting result of the priority P1 is the third, so that the task message M1 can be inserted between the task message M4 and the task message M5.

For another example, the buffer queue includes task messages M3 to M6, priorities P3 to P6 are sequentially 20, 40, 100, and 650, and it is determined that the priority P2 of the task message M2 is 580. The five priorities may be sorted, to determine that a sorting result of the priority P2 is the second, so that the task message M2 can be inserted between the task message M5 and the task message M6.

A process of operation 230 of calculating the first priority of the first task message and inserting the first task message into the first target position of the buffer queue based on the first priority is similar to a process of calculating the second priority of the third task message and inserting the third task message into the second target position of the buffer queue based on the second priority. For details, reference may be made to the descriptions herein.

In some embodiments of this disclosure, it may be further determined whether threads in the task execution system are fully loaded, and the task message transmission process or the task execution system is flexibly adjusted based on a determining result, to improve system stability.

In some examples, a total quantity of all task worker threads in the task execution system may be obtained, and is referred to as a total task thread quantity for short. If the quantity of task worker threads executing the tasks (that is, the execution thread quantity) in the preset time period matches the total task thread quantity, it is determined that the task execution system is in a thread full load state. When the task execution system is in the thread full load state and the execution thread quantity does not match the preset fourth threshold, the task execution system is triggered to add a task worker thread.

When the task execution system is in the thread full load state, the execution thread quantity matches the preset fourth threshold, and a quantity of to-be-transmitted task messages in the thread full load state does not match the execution thread quantity, insertion of a task message into the buffer queue is stopped.

The execution thread quantity is not greater than the total task thread quantity.

If the execution thread quantity matches the total task thread quantity, and the matching may be, for example, the execution thread quantity being equal to the total task thread quantity, or a difference between the execution thread quantity and the total task thread quantity being less than a value, it is determined that the task execution system is in the thread full load state. In this case, first, capacity expansion of the task execution system may be considered, for example, a new task worker thread is added, to meet a high task message processing requirement.

However, there is an upper limit (that is, the fourth threshold) for a quantity of task worker threads that can be configured by the task execution system. Therefore, it may be further determined whether the execution thread quantity is equal to the fourth threshold. If the execution thread quantity is equal to the fourth threshold, the task execution system reaches the capacity expansion upper limit, and a new task worker thread may not be added.

In this case, it may be further determined whether the quantity of to-be-transmitted task messages matches the execution thread quantity. The matching may be, for example, being less than or equal to. If the quantity of to-be-transmitted task messages does not match the execution thread quantity, it may be determined that execution pressure of the task execution system is relatively large. To keep the system stable, insertion of a task message into the buffer queue may be stopped.

For example, a total task thread quantity TSum and an execution thread quantity ESum are obtained. If the execution thread quantity ESum is equal to the total task thread quantity TSum, it is determined that a task execution system E1 is in the thread full load state.

Then, a value relationship between the execution thread quantity ESum and the preset fourth threshold is determined. If the execution thread quantity ESum is less than the preset fourth threshold, the task execution system E1 may be triggered to add a new task worker thread. If the execution thread quantity ESum is equal to the preset fourth threshold, it may be compared whether a total quantity of to-be-transmitted task messages is greater than the execution thread quantity ESum. If the total quantity of to-be-transmitted task messages is greater than the execution thread quantity ESum, insertion of a to-be-transmitted task message into the buffer queue is temporarily stopped.

In this embodiment of this disclosure, task execution data of a task execution system may be obtained, where the task execution data may include related indicator data of the task execution system in a task message processing process; and then execution stage information of the task execution system may be determined based on the task execution data. Different execution stages (represented by the execution stage information) of the task execution system may be determined based on a situation (represented by the task execution data) in which the task execution system processes task messages. If the task execution system is at a first execution stage, and the first execution stage is, for example, a stage at which a processing amount of task messages per unit time is relatively large, in this embodiment of this disclosure, priority scheduling may be performed on a task message to be transmitted at the first execution stage. In some examples, a priority of the task message may be calculated, and the task message may be inserted into a target position of a buffer queue based on the priority, so that a task message with a high priority in the buffer queue can be transmitted to the task execution system more quickly, to effectively improve flexibility of transmitting the task message.

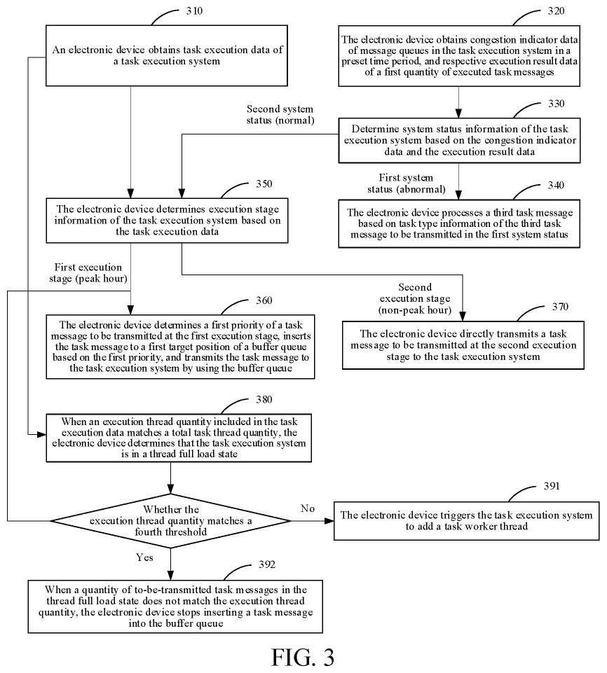

The task message transmission method in this disclosure is further described below with reference to the embodiments. The task message transmission method may be integrated into a task transmission system. The task transmission system may be integrated on an electronic device. The electronic device may be, for example, a server. In some examples, a flowchart of the task message transmission method may be shown in FIG. 3, and the task message transmission method includes the following operations.

310: An electronic device obtains task execution data of a task execution system.

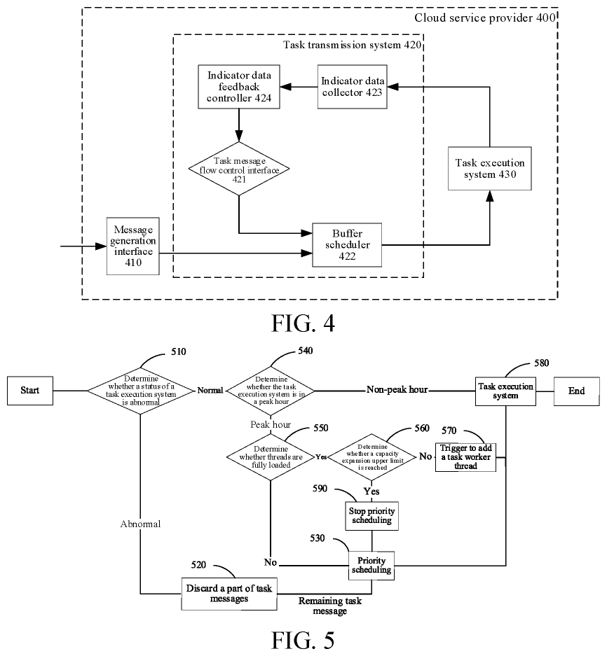

In this embodiment of this disclosure, referring to a schematic structural diagram of a cloud service provider shown in FIG. 4, a cloud service provider 400 may include a message generation interface 410, a task execution system 420, and a task execution system 430. The task execution system 420 includes a task message flow control interface 421, a buffer scheduler 422, an indicator data collector 423, an indicator data feedback controller 424, and the like.

The message generation interface 410 may receive an application programming interface (API) request, including a request message from a cloud service user and/or a control message from a cloud service control platform, generate a task message based on the API request, transmit the task message to the buffer scheduler 422 for buffering, and store the task message in a buffer queue.

The task message flow control interface 421 may determine, based on the task execution data, whether the task execution system 420 is in an abnormal state, whether the task execution system 420 is in a peak hour, whether threads are fully loaded, and the like, to determine system status information of the task execution system 420, and transmit the corresponding system status information to the buffer scheduler 422.

The buffer scheduler 422 may perform priority scheduling on to-be-transmitted task messages in the task transmission system 420 when the task execution system 420 is in the peak hour, the abnormal state, or the like, and transmit, by using the buffer queue, the task messages to the task execution system 430 based on priorities.

The indicator data collector 423 may receive the task execution data reported by the task execution system 430, and transmit the task execution data to the indicator data feedback controller 424. The indicator data feedback controller 424 may process all or a part of the task execution data, to obtain processed task execution data. The indicator data feedback controller 424 may transmit the initially received or processed task execution data to the task message flow control interface 421, to determine an execution stage, a system status, and the like of the task execution system 430.

A frequency and a time interval at which the task execution system 430 reports the task execution data may both be set flexibly, for example, in minutes.

The task execution data may include a plurality of types. For example, task execution data related to a task message throughput may include a total quantity of currently executed tasks, average execution time of a single task, and average task execution time of various task types. In another example, task execution data related to message queues in the task execution system may include a quantity of tasks temporarily stored in a message queue, and a queue congestion indicator. In still another example, task execution data related to task worker threads in the task execution system may include a total task thread quantity, a task processing capability of a single task thread (for example, a quantity of tasks processed per unit time), a quantity of abnormal task threads, and an overall task processing capability of all task threads.

The part of the task execution data is data having a higher weight for determining the system status information of the task execution system 420.

320: The electronic device obtains congestion indicator data of message queues in the task execution system in a preset time period, and respective execution result data of a first quantity of executed task messages.

330: Determine the system status information of the task execution system based on the congestion indicator data and the execution result data.

340: When the system status information represents that the task execution system is in a first system status (that is, the system abnormal state), the electronic device processes a third task message based on task type information of the third task message to be transmitted in the first system status.

350: When the system status information represents that the task execution system is in a second system status (that is, a system normal state), the electronic device determines execution stage information of the task execution system based on the task execution data.

For example, referring to a flowchart in FIG. 5, in 510, the task transmission system may first determine a system status of the task execution system, and may determine whether a task execution success rate is excessively low (the task execution success rate is less than a preset second threshold), determine whether the congestion indicator data is excessively high (the congestion indicator data is greater than a preset third threshold), determine whether system expansion of the task execution system reaches an upper limit (an execution thread quantity is equal to a preset fourth threshold), or the like, to determine whether the task execution system is in the abnormal state.

If the task execution system is in the abnormal state, in 520, a part of to-be-transmitted task messages that has relatively low importance (task type information of a task message matches a preset task type) may be discarded, and a priority of a remaining to-be-transmitted task message may be determined. In 530, the remaining to-be-transmitted task message is inserted into the buffer queue based on the priority.

If the task execution system is in the normal state, in 540, an average task execution quantity of the task execution system may be calculated, and a determination may be made whether the average task execution quantity is greater than a preset first threshold, to determine whether the task execution system is in the peak hour.

360: When the execution stage information represents that the task execution system is at a first execution stage (that is, in the peak hour), the electronic device determines a first priority of a task message to be transmitted at the first execution stage, inserts the task message to a first target position of the buffer queue based on the first priority, and transmits the task message to the task execution system by using the buffer queue.

370: When the execution stage information represents that the task execution system is at a second execution stage (that is, in a non-peak hour), the electronic device directly transmits a task message to be transmitted at the second execution stage to the task execution system.

In an example, referring to the flowchart in FIG. 5, if the task execution system is in the peak hour, a priority of a to-be-transmitted task message may be directly determined, and then the to-be-transmitted task message may be inserted into the buffer queue based on the priority, that is, 530 in FIG. 5 is performed. If the task execution system is in the non-peak hour, a task message may be directly transmitted to the task execution system, that is, 580 in FIG. 5 is performed.

380: When the execution thread quantity included in the task execution data matches the total task thread quantity, the electronic device determines that the task execution system is in a thread full load state.

391: When the task execution system is at the first execution stage and in the thread full load state and the execution thread quantity does not match the preset fourth threshold, the electronic device triggers the task execution system to add a task worker thread.

392: When the task execution system is at the first execution stage in the thread full load state, the execution thread quantity matches the preset fourth threshold, and a quantity of to-be-transmitted task messages in the thread full load state does not match the execution thread quantity, the electronic device stops inserting a task message into the buffer queue.

Referring to the flowchart in FIG. 5, after the task peak hour is determined, in 550, it may be determined whether the total task thread quantity is equal to the execution thread quantity, to determine whether threads in the task execution system are fully loaded. When a load is full, in 560, it is determined whether the execution thread quantity is equal to a maximum thread quantity (that is, the fourth threshold) that can be configured by the task execution system, that is, it is determined whether the execution thread quantity reaches the capacity expansion upper limit. If the execution thread quantity is less than the maximum thread quantity, in 570, the task execution system may be triggered to add a task worker thread. If the execution thread quantity is equal to the maximum thread quantity, in 590, it may be determined whether the execution thread quantity is less than a total quantity of to-be-transmitted task messages. If the execution thread quantity is less than the total quantity of to-be-transmitted task messages, priority scheduling may be stopped, that is, insertion of a task message into the buffer queue may be stopped, to reduce a system load and help ensure system stability.

According to the method in this embodiment of this disclosure, efficient scheduling can be performed based on a priority of a task and a resource demand degree, to improve a response speed and processing efficiency of the task. In addition, a scheduling policy and the priority of the task can be automatically adjusted, to improve utilization and a throughput of a system. In addition, a system detection function and a feedback function are equipped, so that a resource utilization status of the system and a task processing status can be monitored in real time, and adjustment and optimization can be performed based on feedback information. This improves efficiency and precision of task scheduling, optimizes system performance, and improves service stability. The foregoing method has advantages such as high efficiency, intelligence, and stability, and can provide a high-efficient task scheduling service to a public cloud platform, to further improve the system performance and stability.

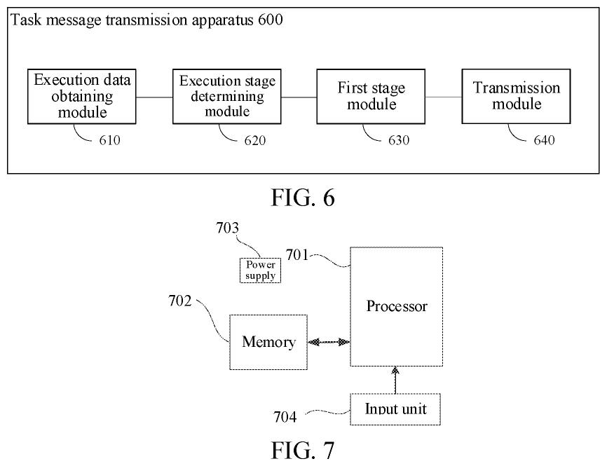

To better implement the foregoing method, an embodiment of this disclosure further provides a task message transmission apparatus. As shown in FIG. 6, a task message transmission apparatus 600 may include an execution data obtaining module 610, an execution stage determining module 620, a first stage module 630, and a transmission module 640.

The execution data obtaining module 610 is configured to obtain task execution data of a task execution system, the task execution system being configured to process a plurality of task messages, and the task execution data including indicator data generated by the task execution system when executing tasks carried in the task messages in a preset time period.

The execution stage determining module 620 is configured to determine execution stage information of the task execution system based on the task execution data.

The first stage module 630 is configured to calculate, when the execution stage information represents that the task execution system is at a first execution stage, a first priority of a first task message to be transmitted at the first execution stage.

The transmission module 640 is configured to insert the first task message into a first target position of a buffer queue based on the first priority, and transmit the first task message to the task execution system by using the buffer queue.

In some embodiments of this disclosure, the task message transmission apparatus further includes a second stage module, where
the second stage module is configured to directly transmit, when the execution stage information represents that the task execution system is at a second execution stage, a task message to be transmitted at the second execution stage to the task execution system.

In some embodiments of this disclosure, the task execution system includes a plurality of message queues configured to store task messages; and the apparatus further includes: an execution result obtaining module, configured to obtain congestion indicator data of the message queues in the task execution system in the preset time period; and obtain respective execution result data of a first quantity of task messages executed by the task execution system in the preset time period; a system status determining module, configured to determine system status information of the task execution system based on the congestion indicator data and the execution result data; and a first status module, configured to process, when the system status information represents that the task execution system is in a first system status, a third task message based on task type information of the to-be-transmitted third task message.

In some embodiments of this disclosure, the first status module includes a discarding submodule and a transmission submodule, where the discarding submodule is configured to discard the third task message when the task type information matches a preset task type; and the transmission submodule is configured to calculate, when the task type information does not match the task type, a second priority of the third task message, insert the third task message into a second target position of the buffer queue based on the second priority, and transmit the third task message to the task execution system by using the buffer queue.

In some embodiments of this disclosure, the task execution system further includes a plurality of task worker threads, the task worker threads are configured to execute the tasks carried in the task messages, and the task execution data includes a task execution quantity of each of the task worker threads in the preset time period and a quantity of task worker threads executing tasks in the preset time period; and the execution stage determining module includes a summation submodule, a fusion submodule, and a determining submodule, where the summation submodule is configured to sum up, when the system status information represents that the task execution system is in a second system status, task execution quantities of the plurality of task worker threads to obtain a total task execution quantity; the fusion submodule is configured to obtain an average task execution quantity of the task execution system based on the total task execution quantity and the quantity of task worker threads executing the tasks; and the determining submodule is configured to determine the execution stage information of the task execution system based on the average task execution quantity.

In some embodiments of this disclosure, the execution stage information includes first stage information and second stage information; and the determining submodule includes a first determining unit and a second determining unit, where the first determining unit is configured to: when the average task execution quantity matches a preset first threshold, determine that the execution stage information is the first stage information, the first stage information representing that the task execution system is at the first execution stage; and the second determining unit is configured to: when the average task execution quantity does not match the first threshold, determine that the execution stage information is the second stage information, the second stage information representing that the task execution system is at the second execution stage.

In some embodiments of this disclosure, the system status determining module includes a target determining submodule, a success rate submodule, and a system status submodule, where the target determining submodule is configured to determine that a task message whose execution result data indicates successful execution is a target task message, and obtain a second quantity of target task messages through statistics collection; the success rate submodule is configured to calculate the task execution success rate of the task execution system based on the first quantity and the second quantity; and the system status submodule is configured to determine the system status information of the task execution system based on the congestion indicator data, the task execution success rate, and the quantity of task worker threads executing the tasks in the preset time period.

In some embodiments of this disclosure, the system status submodule includes a first status unit and a second status unit, where the first status unit is configured to: when the task execution success rate matches a preset second threshold, the congestion indicator data matches a preset third threshold, or the quantity of task worker threads executing the tasks matches a preset fourth threshold, determine that the system status information is first status information, the first status information representing that the task execution system is in the first system status; and the second status unit is configured to: when the task execution success rate does not match the second threshold, the congestion indicator data does not match the third threshold, and the quantity of task worker threads executing the tasks does not match the fourth threshold, determine that the system status information is second status information, the second status information representing that the task execution system is in the second system status.

In some embodiments of this disclosure, the task message transmission apparatus further includes a thread full load module and a thread addition module, where the thread full load module is configured to: when the quantity of task worker threads executing the tasks matches a total quantity of all task worker threads in the task execution system, determine that the task execution system is in a thread full load state; and the thread addition module is configured to: when the task execution system is in the thread full load state and the quantity of task worker threads executing the tasks does not match the fourth threshold, trigger the task execution system to add a task worker thread.

In some embodiments of this disclosure, the task message transmission apparatus further includes a stopping module, where the stopping module is configured to: when the task execution system is in the thread full load state, the quantity of task worker threads executing the tasks matches the fourth threshold, and a quantity of to-be-transmitted task messages in the thread full load state does not match the quantity of task worker threads executing the tasks, stop inserting a task message into the buffer queue.

In some embodiments of this disclosure, the first stage module includes a duration submodule and a priority submodule, where the duration submodule is configured to obtain transmission waiting duration of the first task message, and determine a waiting duration threshold corresponding to the first task message; and the priority submodule is configured to calculate the first priority based on the transmission waiting duration and the waiting duration threshold.

In some embodiments of this disclosure, the priority submodule includes a first calculation unit and a second calculation unit, where the first calculation unit is configured to determine, when the transmission waiting duration is less than or equal to the waiting duration threshold, a first preset score corresponding to the first task message, and calculate the first priority based on the transmission waiting duration and the first preset score; and the second calculation unit is configured to determine, when the transmission waiting duration is greater than the waiting duration threshold, the first preset score and a second preset score corresponding to a difference between the transmission waiting duration and the waiting duration threshold, and calculate the first priority based on the first preset score, the waiting duration threshold, the second preset score, and the difference.

In some embodiments of this disclosure, the first stage module includes a sorting submodule and an insertion submodule, where the sorting submodule is configured to sort the first priority and a priority of at least one task message in the buffer queue, to obtain a sorting result of the first priority; and the insertion submodule is configured to determine the first target position of the first task message in the buffer queue based on the sorting result, and insert the first task message into the first target position.

In some embodiments of this disclosure, the first calculation unit may be configured to: obtain a first preset type score table, the first preset type score table including a plurality of pieces of preset task type information and a preset score corresponding to each piece of task type information; and search the first preset type score table for the first preset score corresponding to task type information of the first task message.

An embodiment of this disclosure further provides an electronic device. FIG. 7 is a schematic structural diagram of an electronic device according to an embodiment of this disclosure. The electronic device may be a terminal, a server, or the like. In some examples:

The electronic device may include components such as a processor 701 including one or more processing cores, a memory 702 including one or more computer-readable storage media, a power supply 703, and an input unit 704. It is noted that the structure of the electronic device shown in FIG. 7 constitutes no limitation on the electronic device, and the electronic device may include more or fewer components than those shown in the figure, or some components may be combined, or a different component deployment may be used.

The processor 701 is a control center of the electronic device, and connects to various parts of the electronic device by using various interfaces and lines. By running or executing the computer program and/or module stored in the memory 702, and invoking data stored in the memory 702, the processor performs various functions and data processing of the electronic device. In one embodiment, the processor 701 may include one or more processing cores. In some aspects, the processor 701 may integrate an application processor and a modem. The application processor processes an operating system, a user interface, a computer program, and the like. The modem processes wireless communication. The foregoing modem may not be integrated into the processor 701.

The memory 702 may be configured to store a computer program and module. The processor 701 runs the computer program and module stored in the memory 702, to implement various functional applications and data processing of the mobile phone. The memory 702 may include a program storage area and a data storage area. The program storage area may store an operating system, a computer program required by at least one function (for example, a sound playing function and an image playing function), or the like. The data storage area may store data created according to use of the electronic device. In addition, the memory 702 may include a high speed random access memory, and may also include a non-volatile memory, such as at least one magnetic disk storage device, a flash memory, or another volatile solid-state storage device. Correspondingly, the memory 702 may further include a memory controller, so that the processor 701 can access the memory 702.

The electronic device may further include the power supply 703 for supplying power to the components. In some aspects, the power supply 703 may be logically connected to the processor 701 by a power management system, thereby implementing functions such as charging, discharging, and power consumption management by using the power management system. The power supply 703 may further include one or more of a direct current or alternating current power supply, a re-charging system, a power failure detection circuit, a power supply converter or inverter, a power supply state indicator, and any other component.

The electronic device may further include the input unit 704. The input unit 704 may be configured to receive entered numeric or character information and generate keyboard, mouse, joystick, optical, or trackball signal input related to user settings and function control.

Although not shown in the figure, the electronic device may further include a display unit, and the like. Details are not described herein again. In some examples, in this embodiment, the processor 701 in the electronic device may load executable files corresponding to processes of one or more computer programs to the memory 702 based on the following instructions, and the processor 701 runs an application program stored in the memory 702, to implement various functions as follows: obtaining task execution data of a task execution system, the task execution system being configured to process a plurality of task messages, and the task execution data including at least one piece of indicator data of the task execution system in a task message processing process; determining execution stage information of the task execution system based on the task execution data; and calculating, if the execution stage information represents that the task execution system is at a first execution stage, a first priority of a first task message to be transmitted at the first execution stage, inserting the first task message to a first target position of a buffer queue based on the first priority, and transmitting the first task message to the task execution system by using the buffer queue.

For an implementation of the foregoing operations, reference may be made to the foregoing embodiments. Details are not described herein again.

It is noted that, all or some steps of the methods in the foregoing embodiments may be implemented through a computer program, or implemented through a computer program controlling relevant hardware, and the computer program may be stored in a computer-readable storage medium and loaded and executed by a processor.

In view of this, an embodiment of this disclosure further provides a computer-readable storage medium, such as a non-transitory computer-readable storage medium, having a computer program stored therein. The computer program can be executed by a processor to implement operations of any task message transmission method provided in the embodiments of this disclosure. For example, the computer program may perform the following operations:
obtaining task execution data of a task execution system, the task execution system being configured to process a plurality of task messages, and the task execution data including at least one piece of indicator data of the task execution system in a task message processing process; determining execution stage information of the task execution system based on the task execution data; and calculating, if the execution stage information represents that the task execution system is at a first execution stage, a first priority of a first task message to be transmitted at the first execution stage, inserting the first task message to a first target position of a buffer queue based on the first priority, and transmitting the first task message to the task execution system by using the buffer queue.

The computer-readable storage medium may include: a read-only memory (ROM), a random access memory (RAM), a magnetic disk, an optical disc, or the like.

The computer program stored in the computer-readable storage medium can perform the operations of any task message transmission method provided in the embodiments of this disclosure. Therefore, beneficial effects that can be implemented by any task message transmission method provided in the embodiments of this disclosure can be achieved. For details, reference is made to the foregoing embodiments. Details are not described herein again.

An embodiment of this disclosure further provides a computer program product. The computer program product stores a computer program, the computer program being stored in a computer-readable storage medium. A processor of an electronic device reads the computer program from the computer-readable storage medium, and the processor executes the computer program, to cause the electronic device to perform the method provided in the various example implementations of the foregoing task message transmission method.

One or more modules, submodules, and/or units of the apparatus can be implemented by processing circuitry, software, or a combination thereof, for example. The term module (and other similar terms such as unit, submodule, etc.) in this disclosure may refer to a software module, a hardware module, or a combination thereof. A software module (e.g., computer program) may be developed using a computer programming language and stored in memory or non-transitory computer-readable medium. The software module stored in the memory or medium is executable by a processor to thereby cause the processor to perform the operations of the module. A hardware module may be implemented using processing circuitry, including at least one processor and/or memory. Each hardware module can be implemented using one or more processors (or processors and memory). Likewise, a processor (or processors and memory) can be used to implement one or more hardware modules. Moreover, each module can be part of an overall module that includes the functionalities of the module. Modules can be combined, integrated, separated, and/or duplicated to support various applications. Also, a function being performed at a particular module can be performed at one or more other modules and/or by one or more other devices instead of or in addition to the function performed at the particular module. Further, modules can be implemented across multiple devices and/or other components local or remote to one another. Additionally, modules can be moved from one device and added to another device, and/or can be included in both devices.

The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

The task message transmission methods and apparatuses, the electronic devices, and the computer-readable storage media provided in the embodiments of this disclosure are described in further detail above. The foregoing disclosure includes some embodiments of this disclosure which are not intended to limit the scope of this disclosure. Other embodiments shall also fall within the scope of this disclosure.

What is claimed is:

1. A method of task message transmission, the method comprising:
obtaining task execution data of a task execution system in a preset time period when the task execution system executes tasks that are carried in a plurality of task messages in the preset time period;
determining execution stage information of the task execution system based on the task execution data;
calculating, when the execution stage information indicates that the task execution system is at a first execution stage corresponding to a peak hour for the task execution system, a first priority of a first task message to be transmitted to the task execution system;
inserting the first task message into a first target position of a buffer queue based on the first priority, and
transmitting the first task message to the task execution system by using the buffer queue.

2. The method according to claim 1, further comprising:
transmitting, when the execution stage information indicates that the task execution system is at a second execution stage corresponding to an off-peak hour for the task execution system, the first task message to the task execution system without queuing in the buffer queue.

3. The method according to claim 2, wherein the task execution system comprises a plurality of message queues configured to store incoming task messages, and the method further comprises:
obtaining congestion indicator data of the plurality of message queues in the task execution system in the preset time period;
obtaining respective execution result data of a first quantity of executed task messages by the task execution system in the preset time period;
determining system status information of the task execution system based on the congestion indicator data and the respective execution result data of the first quantity of executed task messages; and
processing, when the system status information indicates that the task execution system is in a first system status of an abnormal state, a to-be-transmitted task message based on task type information of the to-be-transmitted task message.

4. The method according to claim 3, wherein the processing the to-be-transmitted task message comprises:
when the task type information matches a preset task type, discarding the to-be-transmitted task message; and
when the task type information does not match the preset task type,
calculating a second priority of the to-be-transmitted task message,
inserting the to-be-transmitted task message into a second target position of the buffer queue based on the second priority, and
transmitting the to-be-transmitted task message to the task execution system by using the buffer queue.

5. The method according to claim 3, wherein:
the task execution system further comprises a plurality of task worker threads;
the plurality of task worker threads are configured to execute tasks carried in the incoming task messages;
the task execution data comprises respective task execution quantities of the plurality of task worker threads in the preset time period and a quantity of working task worker threads in the plurality of task worker threads that execute tasks in the preset time period; and
the determining the execution stage information comprises:
summing up, when the system status information indicates that the task execution system is in a second system status of a normal state, the respective task execution quantities of the plurality of task worker threads to obtain a total task execution quantity;
obtaining an average task execution quantity of the task execution system based on the total task execution quantity and the quantity of the working task worker threads; and
determining the execution stage information based on the average task execution quantity.

6. The method according to claim 5, wherein the determining the execution stage information comprises:
when the average task execution quantity is equal to or above a preset first threshold, determining that the execution stage information corresponds to the first execution stage; and
when the average task execution quantity is lower than the preset first threshold, determining that the execution stage information corresponds to the second execution stage.

7. The method according to claim 6, wherein the determining the system status information of the task execution system comprises:
obtaining a second quantity of target task messages that have successful execution results through statistics collection;
calculating a task execution success rate of the task execution system based on the first quantity and the second quantity; and
determining the system status information of the task execution system based on the congestion indicator data, the task execution success rate, and the quantity of working task worker threads.

8. The method according to claim 7, wherein the determining the system status information comprises:
when the task execution success rate satisfies a low success rate condition based on a preset second threshold, the congestion indicator data satisfies a high level congestion condition based on a preset third threshold, or the quantity of working task worker threads satisfies a maximum quantity condition based on a preset fourth threshold, determining that the system status information corresponds to the first system status; and
when the task execution success rate does not satisfy the low success rate condition, the congestion indicator data does not satisfy the high level congestion condition, and the quantity of task worker threads executing the tasks does not satisfy the maximum quantity condition, determining that the system status information corresponds to the second system status.

9. The method according to claim 8, further comprising:
when the quantity of working task worker threads matches a total quantity of the plurality of task worker threads in the task execution system, determining that the task execution system is in a thread full load state; and
when the task execution system is in the thread full load state and the quantity of working task worker threads does not satisfy the maximum quantity condition, triggering the task execution system to add a new task worker thread.

10. The method according to claim 9, further comprising:
when the task execution system is in the thread full load state, the quantity of working task worker threads satisfy the maximum quantity condition, and a quantity of to-be-transmitted task messages in the thread full load state is higher than the quantity of working task worker threads, stopping a task message insertion to the buffer queue.

11. The method according to claim 1, wherein the calculating the first priority of the first task message comprises:
obtaining a transmission waiting duration of the first task message;
determining a waiting duration threshold associated with the first task message; and
calculating the first priority based on the transmission waiting duration and the waiting duration threshold.

12. The method according to claim 11, wherein the calculating the first priority comprises:
when the transmission waiting duration is less than or equal to the waiting duration threshold, determining a first preset score of the first task message, and calculating the first priority based on the transmission waiting duration and the first preset score; and
when the transmission waiting duration is greater than the waiting duration threshold, determining the first preset score and a second preset score associated with a difference between the transmission waiting duration and the waiting duration threshold, and calculating the first priority based on the first preset score, the waiting duration threshold, the second preset score, and the difference.

13. The method according to claim 1, wherein the inserting the first task message into the first target position of the buffer queue based on the first priority comprises:
sorting the first priority and a priority of at least one task message in the buffer queue, to obtain a sorting result of the first priority; and
determining the first target position of the first task message in the buffer queue based on the sorting result.

14. The method according to claim 12, wherein the determining the first preset score of the first task message comprises:
obtaining a first preset type score table, the first preset type score table comprising a plurality of preset task types and corresponding preset scores; and
searching the first preset type score table for the first preset score corresponding to a task type of the first task message.

15. An apparatus, comprising processing circuitry configured to:
obtain task execution data of a task execution system in a preset time period when the task execution system executes tasks that are carried in a plurality of task messages in the preset time period;
determine execution stage information of the task execution system based on the task execution data;
calculate, when the execution stage information indicates that the task execution system is at a first execution stage corresponding to a peak hour for the task execution system, a first priority of a first task message to be transmitted to the task execution system;
insert the first task message into a first target position of a buffer queue based on the first priority, and
transmit the first task message to the task execution system by using the buffer queue.

16. The apparatus according to claim 15, wherein the processing circuitry is configured to:
transmit, when the execution stage information indicates that the task execution system is at a second execution stage corresponding to an off-peak hour for the task execution system, the first task message to the task execution system without queuing in the buffer queue.

17. The apparatus according to claim 16, wherein the task execution system comprises a plurality of message queues configured to store incoming task messages; and the processing circuitry is configured to:
obtain congestion indicator data of the plurality of message queues in the task execution system in the preset time period;
obtain respective execution result data of a first quantity of executed task messages by the task execution system in the preset time period;
determine system status information of the task execution system based on the congestion indicator data and the respective execution result data of the first quantity of executed task messages; and
process, when the system status information indicates that the task execution system is in a first system status of an abnormal state, a to-be-transmitted task message based on task type information of the to-be-transmitted task message.

18. The apparatus according to claim 17, wherein the processing circuitry is configured to:
when the task type information matches a preset task type, discard the to-be-transmitted task message; and
when the task type information does not match the preset task type,
calculate a second priority of the to-be-transmitted task message,
insert the to-be-transmitted task message into a second target position of the buffer queue based on the second priority, and
transmit the to-be-transmitted task message to the task execution system by using the buffer queue.

19. The apparatus according to claim 17, wherein:
the task execution system further comprises a plurality of task worker threads;
the plurality of task worker threads are configured to execute tasks carried in the incoming task messages;
the task execution data comprises respective task execution quantities of the plurality of task worker threads in the preset time period and a quantity of working task worker threads in the plurality of task worker threads that execute tasks in the preset time period; and
the processing circuitry is configured to:
sum up, when the system status information indicates that the task execution system is in a second system status of a normal state, the respective task execution quantities of the plurality of task worker threads to obtain a total task execution quantity;
obtain an average task execution quantity of the task execution system based on the total task execution quantity and the quantity of the working task worker threads; and
determine the execution stage information based on the average task execution quantity.

20. A non-transitory computer-readable storage medium storing instructions which when executed by at least one processor cause the at least one processor to perform:
obtaining task execution data of a task execution system in a preset time period when the task execution system executes tasks that are carried in a plurality of task messages in the preset time period;
determining execution stage information of the task execution system based on the task execution data;
calculating, when the execution stage information indicates that the task execution system is at a first execution stage corresponding to a peak hour for the task execution system, a first priority of a first task message to be transmitted to the task execution system;
inserting the first task message into a first target position of a buffer queue based on the first priority, and
transmitting the first task message to the task execution system by using the buffer queue.
